(19) United States
(12) Patent Application Publication
(10) Pub. No.: US 2026/0364837 A1
(43) Pub. Date: Nov. 19, 2026

(54) RAZOR ASSEMBLY

(71) Applicant: DORCO CO., LTD., Seoul (KR)

(72) Inventors: Seung Min SONG, Seoul (KR); Won Jun JO, Seoul (KR)

(21) Appl. No.: 19/681,667

(22) Filed: May 19, 2026

(30) Foreign Application Priority Data
May 19, 2025 (KR) 10-2025-0064447
May 18, 2026 (KR) 10-2026-0089790

(51) Int. Cl. B26B 21/40; B26B 21/22

(52) U.S. Cl. CPC B26B 21/4012; B26B 21/225; B26B 21/4037

(57) ABSTRACT

A razor assembly may include a razor cartridge including a blade housing that extends longitudinally to receive at least one razor blade, and a razor handle including a grip portion grasped by a user and a head portion configured to be connected to the razor cartridge. The razor assembly may also include a cartridge protector including a receiving space configured to receive at least a portion of the razor cartridge. The razor cartridge may include a cartridge upper surface where a cutting edge of the at least one razor blade is exposed and a cartridge lower surface opposite to the cartridge upper surface in a thickness direction. The cartridge protector may include a bottom wall, a front wall, and a side support When the razor assembly is stacked above another razor assembly, the side support may contact at least a portion of the head portion of the other razor assembly.

### CROSS-REFERENCE TO RELATED APPLICATIONS

This application is based on, and claims priority from, Korean Patent Application Number 10-2025-0064447, filed May 19, 2025, and Korean Patent Application Number 10-2026-0089790, filed May 18, 2026, the disclosure of each of which is incorporated herein its entirety.

### BACKGROUND

### Technical Field

The disclosure relates to a razor assembly.

### Description of Related Technology

Razor assemblies may be packaged and handled in individual units or in multiple units during the distribution and sales process. In this case, multiple razor assemblies may be packaged in a state where they are arranged in a certain direction or stacked vertically, and the arrangement structure of the product may be designed in various ways depending on the packaging form. In addition, the external appearance, structure, mutual arrangement relationship, and arrangement stability in the packaged state of a razor assembly may be closely related to the handling method in the packaging process.

### SUMMARY

One aspect is to improve packaging efficiency and handling convenience by enabling a plurality of razor assemblies to be stably stacked in the height direction or easily aligned in the horizontal direction.

The aspects to be achieved by the disclosure are not limited to the aspects mentioned above, and other aspects not mentioned will be clearly understood by those skilled in the art from the description below.

Another aspect is a razor assembly configured to be stackable relative to another razor assembly having the same size and shape, the razor assembly including: a razor cartridge including a blade housing that extends longitudinally to receive at least one razor blade; a razor handle including a grip portion grasped by a user and a head portion configured to be connected to the razor cartridge; and a cartridge protector including a receiving space configured to receive at least a portion of the razor cartridge, wherein the razor cartridge includes a cartridge upper surface where a cutting edge of the at least one razor blade is exposed and a cartridge lower surface opposite to the cartridge upper surface in a thickness direction, wherein the cartridge protector includes a bottom wall configured to face the cartridge upper surface, a front wall disposed in front of the receiving space, and a side support formed by recessing of at least one of the front wall and the bottom wall, with at least a portion exposed in the thickness direction, and wherein, when the razor assembly is stacked above the other razor assembly in a stacking direction, the side support is configured to contact at least a portion of the head portion of the other razor assembly.

Another aspect is a razor assembly, including: a razor cartridge including a blade housing extending longitudinally to receive at least one blade; and a razor handle including a head portion configured to be connected to the razor cartridge, a grip portion extending from the head portion, and an engaging portion formed protruding downward from the head portion, wherein the razor assembly is configured such that, with respect to another razor assembly having the same size and shape, it is possible that razor cartridges of the razor assembly and the other razor assembly are aligned longitudinally and misaligned from each other while facing the same direction, and wherein, in an alignment state in which the razor cartridges of the razor assembly and the other razor assembly are aligned longitudinally and misaligned from each other while facing the same direction, one side surface of the engaging portion is configured to contact at least a portion of a rear surface of the blade housing of the other razor assembly.

Another aspect are a plurality of razor assemblies including a razor assembly and another razor assembly having the same size and shape as the razor assembly and configured to be stackable relative to the razor assembly, wherein each of the razor assembly and the other razor assembly includes: a razor cartridge including a blade housing that extends longitudinally to receive at least one razor blade; a razor handle including a head portion configured to be connected to the razor cartridge; and a cartridge protector including a receiving space configured to receive at least a portion of the razor cartridge, wherein the razor cartridge includes a cartridge upper surface where a cutting edge of the at least one razor blade is exposed and a cartridge lower surface opposite to the cartridge upper surface in a thickness direction, wherein the cartridge protector includes a bottom wall configured to face the cartridge upper surface, a front wall disposed in front of the receiving space, and a side support formed by recessing of at least one of the front wall and bottom wall, with at least a portion exposed in the thickness direction, and wherein, while the razor assembly is stacked at the upper side of the stacking direction of the other razor assembly, the side support of the razor assembly is configured to contact at least a portion of the head portion of the other razor assembly.

Another aspect is a razor assembly system including a razor assembly and another razor assembly having the same size and shape as the razor assembly, wherein each of the razor assembly and the other razor assembly includes: a razor cartridge including a blade housing that extends longitudinally to receive at least one razor blade; a razor handle including a grip portion configured to be grasped by a user and a head portion configured to be connected to the razor cartridge; and a cartridge protector including a receiving space configured to receive at least a portion of the razor cartridge and a front wall disposed in front of the receiving space, wherein, in a stacked state in which the razor assembly is stacked above the other razor assembly in a stacking direction, at least one region of the cartridge protector of the razor assembly is configured to contact at least one region of the head portion of the other razor assembly at two or more points, and a lower end surface of the razor handle of the razor assembly is configured to contact a upper end surface of the razor handle of the other razor assembly, thereby forming a seating structure having contact at three or more points; wherein, in an arrangement state in which the razor assembly and the other razor assembly are arranged in the longitudinal direction, in a reverse arrangement state in which razor cartridges of the razor assembly and the other razor assembly face opposite directions, contact with the other razor assembly is possible at at least four points including one longitudinal side of the head portion of the razor assembly, one longitudinal side of the connecting portion included in the grip portion of the razor assembly, a rear portion of one longitudinal side of a placing portion included in the grip portion of the razor assembly, and an end portion of one longitudinal side of the placing portion of the razor assembly, or wherein, in an alignment state in which the razor cartridges of the razor assembly and the other razor assembly are misaligned from each other while facing the same direction, the longitudinal side of the head portion of the razor assembly is configured to contact at least a portion of the rear of the blade housing of the other razor assembly, and the longitudinal side of the placing portion of the razor assembly is configured to contact the other longitudinal side of the placing portion of the other razor assembly.

According to an embodiment, a plurality of razor assemblies are designed to be stably stacked or aligned, so that the stacked or aligned arrangement of the plurality of razor assemblies can be maintained even during the packaging process, and this structural feature has an effect of improving the efficiency of storage and transport of the packaged razor assemblies.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is an assembled perspective view of a razor assembly according to a first embodiment of the disclosure.

FIG. 2 is an assembled perspective view of the razor assembly of FIG. 1 viewed from the bottom.

FIG. 3 illustrates a state in which a cartridge protector is separated from the razor assembly of FIG. 1.

FIG. 4 is an assembled perspective view of a razor assembly according to a second embodiment of the disclosure.

FIG. 5 illustrates a state in which a cartridge protector is separated from the razor assembly of FIG. 4.

FIG. 6 is a side view cut in the A-A′ direction in a stacked state of a plurality of razor assemblies according to the first embodiment of FIG. 1.

FIG. 7 is a side view cut in the B-B′ direction in a stacked state of a plurality of razor assemblies according to the first embodiment of FIG. 1.

FIG. 8 is a cross-sectional view cut in the C-C′ direction in a stacked state of a plurality of razor assemblies according to the first embodiment of FIG. 3.

FIG. 9 is a side view cut in the D-D′ direction in a stacked state of a plurality of razor assemblies according to the second embodiment of FIG. 4.

FIG. 10 is a cross-sectional view cut in the E-E′ direction in a stacked state of a plurality of razor assemblies according to the second embodiment of FIG. 5.

FIG. 11 is a view showing two razor assemblies according to the first embodiment being aligned longitudinally while facing different directions.

FIG. 12 is a view showing two razor assemblies according to the second embodiment being aligned longitudinally while facing different directions.

FIG. 13 is a front view showing a plurality of razor assemblies according to the first embodiment being aligned longitudinally.

FIG. 14 is a partial magnified view of a portion of FIG. 13 showing a head portion, razor cartridge, and cartridge protector of the longitudinally aligned razor assemblies.

FIG. 15 is a front view showing a plurality of razor assemblies according to the second embodiment being aligned longitudinally.

FIG. 16 is a partial magnified view of a portion of FIG. 15 showing a head portion, razor cartridge, and cartridge protector of the longitudinally aligned razor assemblies.

FIG. 17 is a view showing a razor assembly system in which a plurality of razor assemblies according to the first embodiment are stacked and aligned longitudinally while facing different directions.

FIG. 18 is a view showing razor assembly system in which a plurality of razor assemblies according to the first embodiment being stacked and aligned longitudinally while facing the same direction.

### DETAILED DESCRIPTION

Existing razor assemblies lack structures designed to ensure that multiple units are stably stacked or aligned in a certain direction, resulting in problems such as the generation of unnecessary space or reduced packaging and storage efficiency during the packaging process of multiple razor assemblies.

Hereinafter, some embodiments of the disclosure will be described in detail with reference to exemplary drawings. It should be noted that in assigning reference numerals to the components of each drawing, the same components are given the same reference numeral whenever possible, even if they are shown in different drawings. Furthermore, in describing the disclosure, if it is determined that a detailed description of related known components or functions could obscure the essence of the disclosure, such detailed description is omitted.

In describing the components of the embodiments according to the disclosure, reference numerals such as first, second, i), ii), a), b), etc., may be used. These reference numerals are intended only to distinguish the component from other components, and the essence, order, or sequence of the component is not limited by the reference numeral. When a part in the specification is described as “including” or “having” a certain component, this means that, unless explicitly stated otherwise, it does not exclude other components but may include additional components.

Where it is stated that one component is “connected,” “coupled,” or “linked” to another component, it should be understood that while the component may be directly connected or linked to the other component, another component may also be “connected,” “coupled,” or “linked” in between.

Terms such as “ . . . portion,” “module,” etc., as used in the specification refer to a unit that processes at least one function or operation, which may be implemented in hardware, software, or a combination of hardware and software.

Unless otherwise stated, it should be noted that the description of any one embodiment may apply to other embodiments.

The description of the invention disclosed below, together with the accompanying drawings, is intended to describe exemplary embodiments of the disclosure and is not intended to represent the only embodiment in which the invention can be carried out.

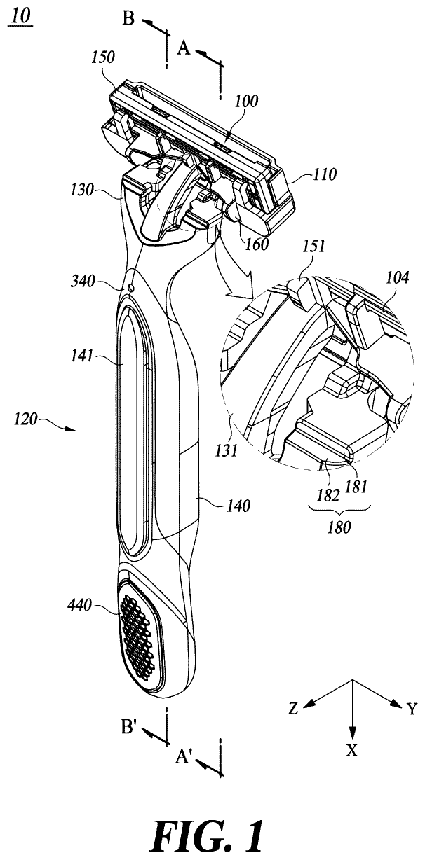

FIG. 1 is an assembled perspective view of a razor assembly according to an embodiment of the disclosure.

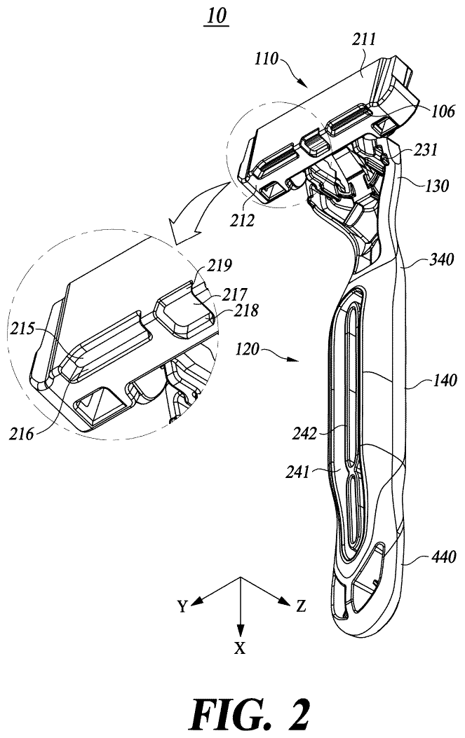

FIG. 2 is an assembled perspective view of the razor assembly of FIG. 1 viewed from the bottom. FIG. 2 shows a portion of a razor assembly according to an embodiment of the present disclosure in a partial magnified view, and in the partial magnified view, the razor assembly is shown in a state in which the razor cartridge is omitted in order to more clearly show a shape of the cartridge protector.

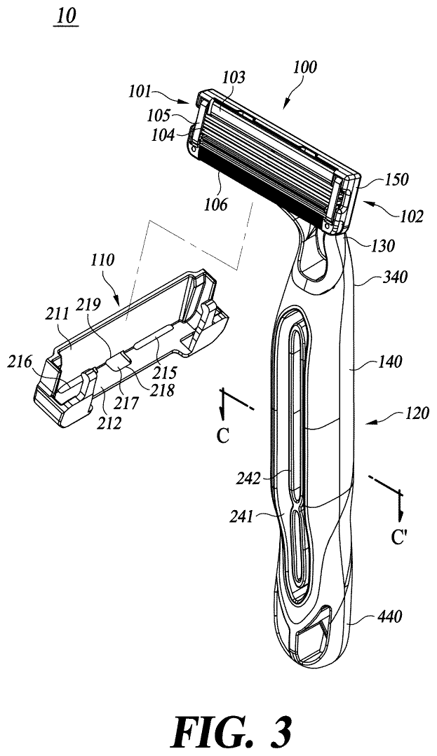

FIG. 3 illustrates a state in which a cartridge protector 110 is separated from the razor assembly of FIG. 1.

Referring to FIGS. 1 to 3, a razor assembly 10 according to a first embodiment of the disclosure may include a razor cartridge 100, a razor handle 120, a cartridge protector 110, and a connector 160.

The razor cartridge 100 of the razor assembly 10 according to the first embodiment of the disclosure includes a blade housing 150 that receives at least one razor blade 104, each having a cutting edge (not shown). The blade housing 150 may extend longitudinally to receive at least one razor blade 104 longitudinally.

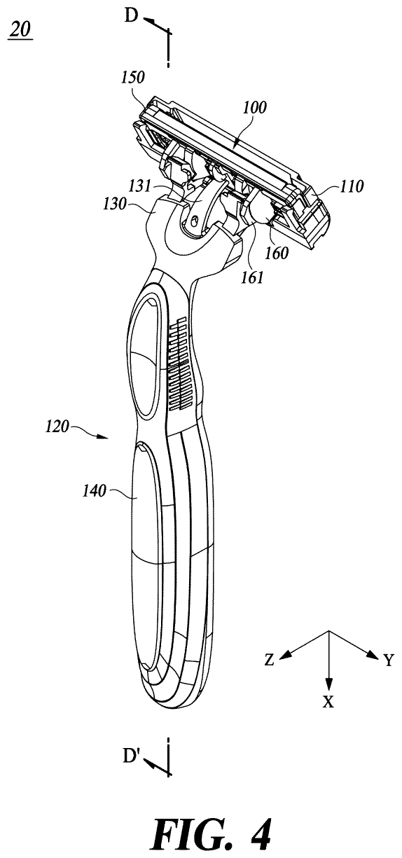

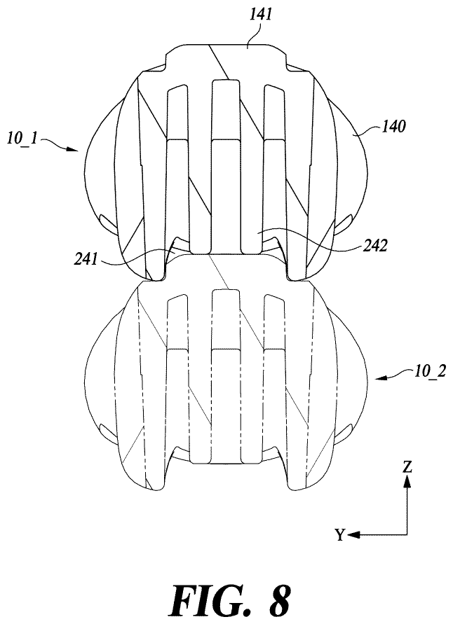

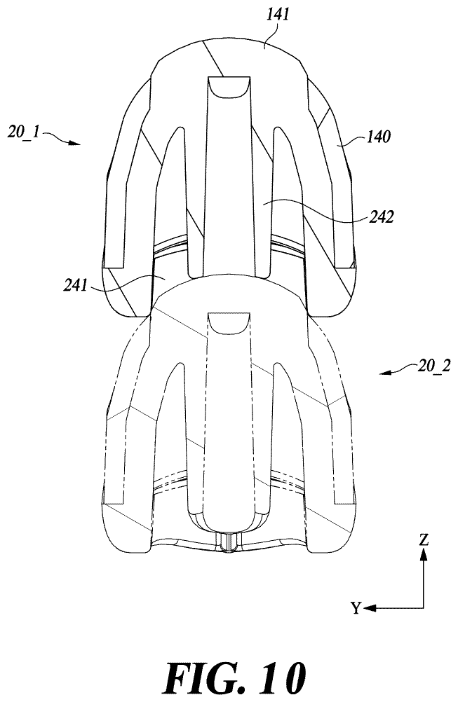

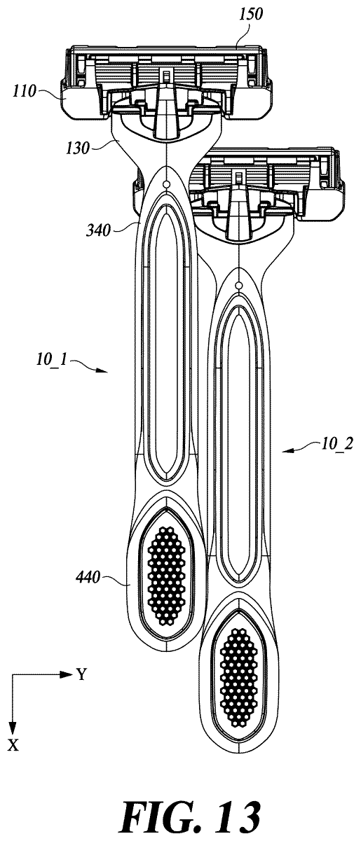

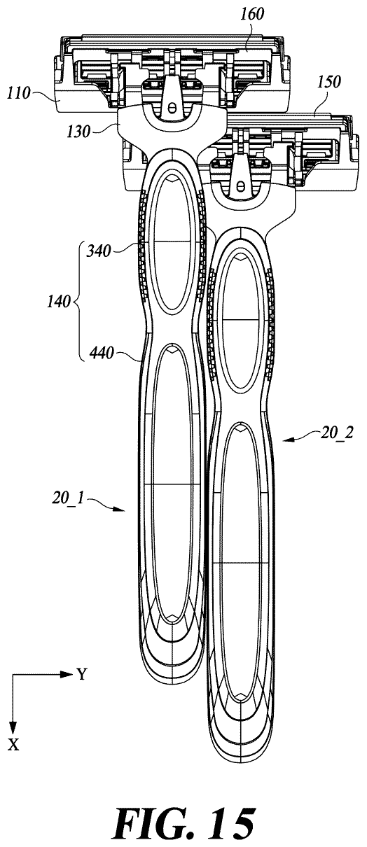

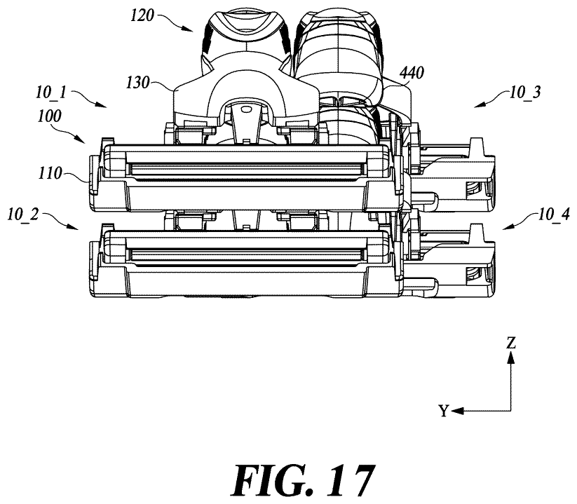

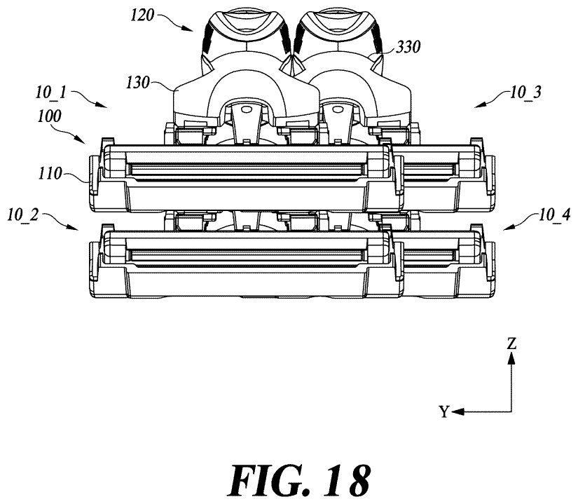

In the disclosure, “longitudinal” may refer to the length direction of the razor cartridge 100. For example, the longitudinal direction may be parallel to the Y axis with reference to FIG. 1, FIG. 2, FIG. 4, FIG. 8, FIG. 10, FIG. 13, FIG. 15, FIG. 17, and FIG. 18.

In the disclosure, “transverse” may refer to the width direction of the razor cartridge 100, and may be perpendicular to the longitudinal direction and parallel to the shaving direction.

The razor cartridge 100 may include all or part of a cap 103, a fixing member 105, a guard 106, a cartridge upper surface 101, and a cartridge lower surface 102. The surface on the razor cartridge 100 where the cutting edge of the razor blade 104 is exposed can be defined as the cartridge upper surface 101, and the surface opposite to the cartridge upper surface 101 in the thickness direction of the razor cartridge 100 can be defined as the cartridge lower surface 102.

The cap 103 may be positioned on the cartridge upper surface 101. The cap 103 may be disposed at the rear of at least one razor blade 104. The cap 103 may contain a lubrication material, thereby performing a function of protecting a user's skin during shaving.

The fixing member 105 may be disposed at a longitudinal side of the cartridge upper surface 101. At least one razor blade 104 may be held while being received in the blade housing 150 by the fixing member 105, and for example, the fixing member 105 may be a clip.

The guard 106 may be disposed on the cartridge upper surface 101 and may be disposed in front of the razor blade 104. The guard 106 may pull the skin in the shaving direction before the razor blade 104 cuts the body hair during shaving. By the guard 106, a user's body hair may be made to stand in a direction perpendicular to the user's skin surface, thereby allowing the razor blade 104 to cut the body hair more easily.

In describing the razor cartridge 100 and cartridge protector 110 in this specification, “front” is defined based on the shaving direction and may be a direction perpendicular to the longitudinal direction.

In describing the razor cartridge 100 and cartridge protector 110 in this specification, “rear” is defined based on the shaving direction in the opposite direction to the front and may be a direction parallel to the front and perpendicular to the longitudinal direction.

The blade housing 150 may include a housing protrusion 151. The housing protrusion 151 may be formed protruding from the cartridge lower surface 102. The housing protrusion 151 may be configured to contact a cantilever 131 which will be described later.

The cartridge protector 110 may include a receiving space configured to receive at least a portion of the razor cartridge 100. The cartridge protector 110 may be configured to be coupled with the razor cartridge 100. With the razor cartridge 100 received in the receiving space, the cartridge protector 110 may cover the razor blade 104 of the razor cartridge 100. This prevents safety issues such as the razor blade 104 being damaged by an external force, impact, etc., or the user being cut by the razor blade 104.

Referring to FIG. 1, the connector 160 may perform a function of connecting a head portion 130, which will be described later, and the blade housing 150. The connector 160 may be manufactured as a separate component from the blade housing 150 and then connected to the blade housing 150, but the disclosure is not necessarily limited thereto, and it is also possible for the connector 160 and the blade housing 150 to be manufactured as a single unit.

Referring to FIG. 2 and FIG. 3, the cartridge protector 110 according to the first embodiment of the disclosure may include all or part of a bottom wall 211, a front wall 212, a side support 216, a central opening 217, a side opening 215, a central receiving portion 218, and a rear receiving portion 219.

The bottom wall 211 may be configured to face the cartridge upper surface 101. By the bottom wall 211 facing the cartridge upper surface 101, the razor blade 104 may be prevented from being damaged by an external force or impact. The bottom wall 211 may be disposed at the lower side in the height direction of the receiving space.

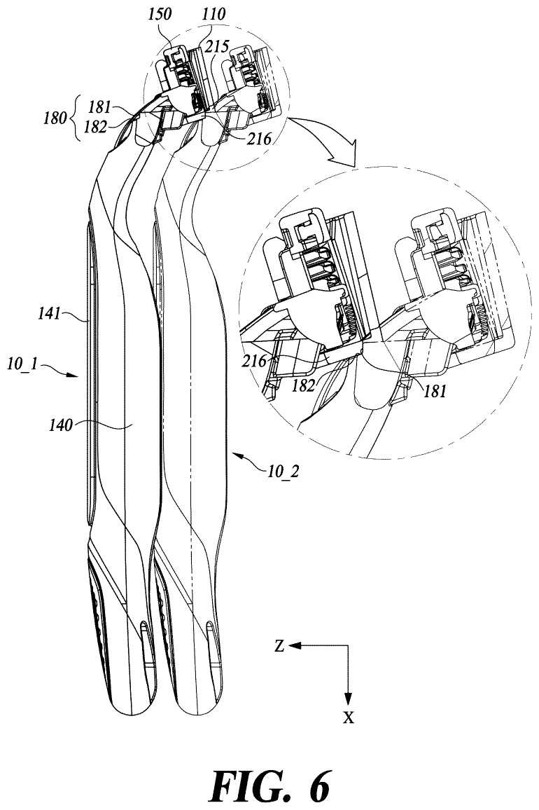

In the disclosure, the “height direction” is a direction perpendicular to the longitudinal direction, and may be parallel to the Z axis, for example, with reference to FIG. 1, FIG. 2, FIG. 4, FIGS. 6 to 10, FIG. 14, and FIGS. 16 to 18.

The front wall 212 may be disposed in front of the receiving space of the cartridge protector 110. The front wall 212 may be configured to extend from the bottom wall 211 in the thickness direction of the razor cartridge 100.

The side support 216 is formed by recessing of at least one of the front wall 212 and bottom wall 211, and at least a portion may be exposed in the thickness direction. The side support 216 may be disposed at opposite longitudinal sides of the central receiving portion 218 which will be described later, but is not necessarily limited thereto, and may be disposed only in the longitudinal center of the central receiving portion 218. The side support 216 may be a surface that extends in the transverse direction and in a direction parallel to the longitudinal direction.

The side opening 215 refers to an opening formed by recessing of at least one of the front wall 212 and bottom wall 211 of the cartridge protector 110. The side opening 215 may be formed through in the thickness direction and/or transverse direction. The side opening 215 may be disposed at a rear side of the side support 216. The side opening 215 may be disposed at opposite longitudinal sides of the central opening 217, which will be described later.

The central opening 217 may be formed by penetrating at least a portion of the front wall 212 and at least a portion of the bottom wall 211. The central opening 217 may be formed by penetrating in the thickness direction, or may be formed by penetrating in the thickness direction and the transverse direction. The central opening 217 may be disposed at a longitudinal side of the side opening 215.

The central receiving portion 218 may be formed by recessing at least a portion of one of the front wall 212 and the bottom wall 211. At least a portion of the central receiving portion 218 may be exposed in the thickness direction of the razor cartridge 100. The central receiving portion 218 may be disposed in front of the central opening 217. The central receiving portion 218 may be disposed at a longitudinal side of the side support 216.

The rear receiving portion 219 may be formed by recessing of a portion of at least one of the front wall 212 and the bottom wall 211. At least a portion of the rear receiving portion 219 may be exposed in the transverse direction. The rear receiving portion 219 may be disposed at the rear of the central receiving portion 218. The rear receiving portion 219 may be disposed at a longitudinal side of the side support 216.

The razor handle 120 of the razor assembly 10 according to the first embodiment of the disclosure may include a grip portion 140 that is held by a user and a head portion 130 configured to be connected to the razor cartridge 100.

The head portion 130 may be configured to be disposed at one side of the razor handle that faces the razor cartridge 100 from the grip portion 140 and connected to the razor cartridge 100. The head portion 130 may include a seating portion 180 and a cantilever 131.

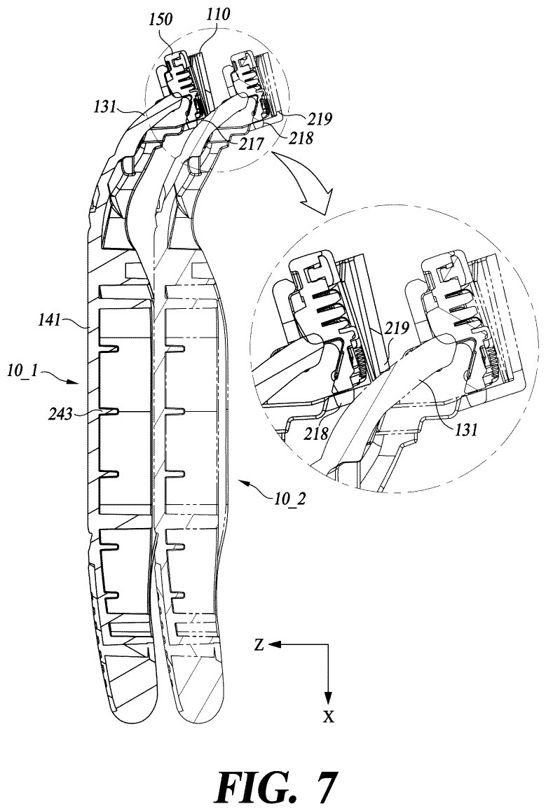

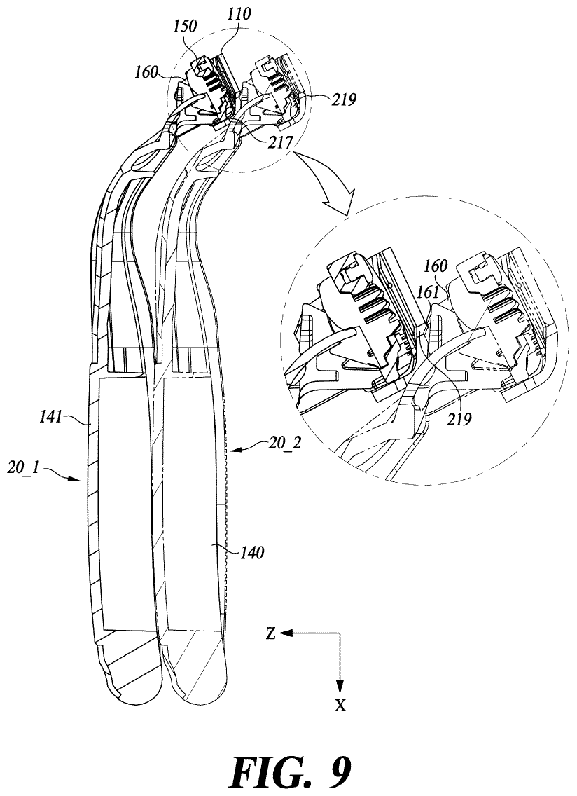

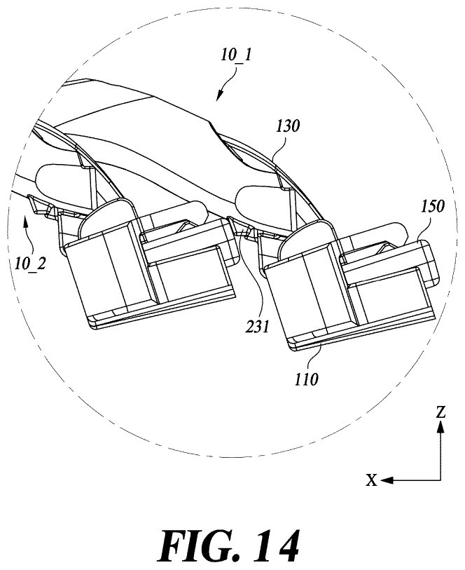

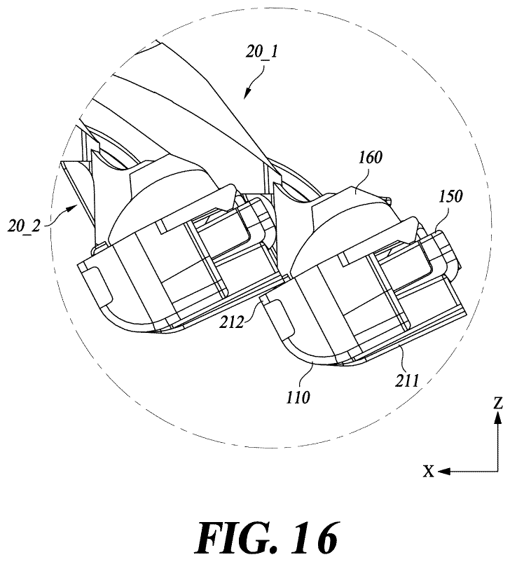

In the disclosure, the “one direction of the razor handle 120” may mean a direction facing the razor cartridge 100 from the razor handle 120. For example, the one direction of the razor handle 120 may be parallel to the X axis with reference to FIG. 1, FIG. 2, FIG. 4, FIG. 6, FIG. 7, FIG. 9, FIG. 14, and FIG. 16.

The seating portion 180 may be formed by recessing of at least a portion of the outer surface of the head portion 130. The seating portion 180 may be formed on the upper surface in the height direction of the head portion. The seating portion 180 may be disposed at a longitudinal side of the cantilever 131.

The seating portion 180 may include a horizontal support surface 181 and a front support surface 182. The horizontal support surface 181 may refer to a surface exposed upward in the height direction. The horizontal support surface 181 may be disposed at one side of the rear of the front support surface 182. The horizontal support surface 181 may be formed extending from a lower end in the height direction of the front support surface 182. In an embodiment, the horizontal support surface 181 may extend from a lower end in the height direction of the front support surface 182 to the one direction of the razor handle 120.

In the disclosure, the “other direction of the razor handle 120” may be a direction opposite to the one direction the razor handle 120.

The front support surface 182 may be formed extending upward in the height direction from the front end of the horizontal support surface 181. The front support surface 182 may refer to a surface exposed in a direction facing the razor cartridge 100. For example, the front support surface 182 may be a surface exposed to the one direction of the razor handle 120. The horizontal support surface 181 and the front support surface 182 may perform a function of supporting another razor assembly 10 stacked when the razor assembly 10 according to the first embodiment is stacked in the height direction. However, the disclosure is not necessarily limited thereto, and the extending direction and exposure direction of the horizontal support surface 181 and the front support surface 182 may differ depending on the recessed direction of the seating portion 180. The shapes of the horizontal support surface 181 and the front support surface 182 may be appropriately changed within a range that can stably maintain the stacked structure of the first razor assembly 10.

A cantilever 131 may be formed protruding from the head portion 130 and configured to support at least a portion of the blade housing 150. When the razor cartridge 100 pivots with respect to the razor handle 120, the cantilever 131 may provide a restoring force to the razor cartridge 100. That is, the cantilever 131 may support at least a portion of the cartridge lower surface 102 of the razor cartridge 100, and may provide a restoring force that allows the razor cartridge 100 to be restored to a resting position, by contacting the blade housing 150, if the razor cartridge 100 is configured to be pivotable about an axis extending longitudinally.

The cantilever 131 may be configured to support at least a portion of the blade housing 150 in contact therewith. The cantilever 131 may be configured to support the blade housing 150 by contacting the housing protrusion 151. At least a portion of an upper surface of the cantilever 131 contacts at least a portion of a front surface of the housing protrusion 151, thereby stably supporting the razor cartridge 100 and preventing the razor cartridge 100 from moving out in the transverse direction.

The grip portion 140 may be formed extending from the head portion 130 to the other direction of the razor handle 120. At least a portion of a longitudinal side surface of the grip portion 140 may be formed in the shape of a continuous curved surface. Therefore, when a plurality of razor assemblies 10 are packaged, the arrangement of the plurality of razor assemblies 10 can be maintained more stably, and packaging alignment can be ensured.

The grip portion 140 may include all or part of a grip protrusion 141, a grip groove 241, and at least one body rib 242. The grip protrusion 141, grip groove 241, and body rib 242 may perform a function of supporting another razor assembly 10 stacked when the razor assembly 10 according to the first embodiment is stacked in the height direction.

A grip protrusion 141 may be formed protruding from at least a portion of one side surface of the grip portion 140. A grip protrusion 141 may be formed protruding from the upper surface in the height direction of the grip portion 140. The protruding direction of the grip protrusion 141 may be perpendicular to the direction in which the grip portion 140 extends. The protruding direction of the grip protrusion 141 may be parallel to the height direction, but the disclosure is not necessarily limited thereto.

A grip groove 241 may be formed by recessing of at least a portion of the other side surface of the grip portion 140 opposite to one side surface of the grip portion 140. A grip groove 241 may be formed by recessing from the lower surface in the height direction of the grip portion 140.

Each of at least one body rib 242 may be formed protruding from an end of the grip groove 241 toward the other side of the grip portion 140. Each of at least one body rib 242 may be formed extending in a direction parallel to the extending direction of the grip portion 140. Each of at least one body rib 242 may be formed protruding downward in the height direction, but the disclosure is not necessarily limited thereto.

The grip portion 140 of the razor assembly 10 according to the first embodiment of the disclosure may include a connecting portion 340 and a placing portion 440. The connecting portion 340 may be disposed adjacent to the head portion 130. The connecting portion 340 may be formed extending from the head portion 130 toward the other direction of the razor handle 120.

The placing portion 440 may be formed extending from the connecting portion 340. The placing portion 440 may be disposed at the other direction of the razor handle 120 of the connecting portion 340. The placing portion 440 may perform a function of placing the razor assembly 10 and can allow the razor assembly 10 to be stably seated on the seating surface.

FIG. 4 is an assembled perspective view of a razor assembly according to a second embodiment of the disclosure.

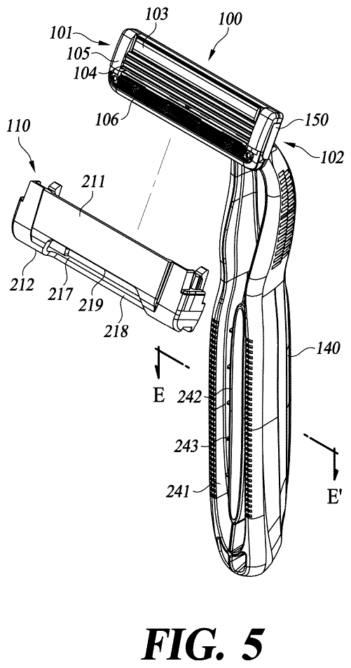

FIG. 5 illustrates a state in which a cartridge protector is separated from the razor assembly of FIG. 4.

Referring to FIGS. 4 and 5, a razor assembly 20 according to the second embodiment of the disclosure may include a razor cartridge 100, a razor handle 120, and a cartridge protector 110.

The razor cartridge 100, the razor handle 120, the cartridge protector 110, and a connector 160 of the razor assembly 20 according to the second embodiment are substantially identical to the razor cartridge 100, the razor handle 120, the cartridge protector 110, and the connector 160 of the razor assembly 10 according to the first embodiment described above, unless otherwise specifically explained, so a redundant description is omitted.

Referring to FIG. 5, the cartridge protector 110 of the razor assembly 20 according to the second embodiment of the disclosure may include all or part of a bottom wall 211, a front wall 212, a central opening 217, a central receiving portion 218, and a rear receiving portion 219.

The bottom wall 211 and the front wall 212 of the razor assembly 20 according to the second embodiment of the disclosure are substantially identical to the bottom wall 211 and the front wall 212 of the razor assembly 10 according to the first embodiment described above, unless otherwise specifically explained, so a redundant description is omitted.

The central opening 217 of the razor assembly 20 according to the second embodiment of the disclosure may be formed by penetrating at least a portion of the front wall 212 and at least a portion of the bottom wall 211. The central opening 217 may be formed by penetrating in the thickness direction, or may be formed by penetrating in the thickness direction and the transverse direction. The central opening 217 may be configured to have a shape in which the longitudinal width narrows toward the rear side on the bottom wall 211. In this case, the longitudinal length of the central receiving portion 218 may be configured to be longer than the longitudinal length of the rear receiving portion 219, but the disclosure is not necessarily limited thereto.

The razor assembly 10 according to the first embodiment of the disclosure may be configured to be stackable with another razor assembly having the same size and shape. During the packaging process of the razor assembly 10, by stably maintaining the stacked state of a plurality of razor assemblies 10, the stability and efficiency of the packaging process can be improved by preventing disruption of the arrangement or separation from one another.

Hereinafter, a structure in which the razor assembly 10 according to the first embodiment of the disclosure is stacked in the height direction will be described.

FIG. 6 is a side view cut in the A-A′ direction in a stacked state of a plurality of razor assemblies according to the first embodiment of FIG. 1. In FIGS. 6, 7, and 8, to indicate that the razor assemblies 10 according to the first embodiment are stacked in the height direction, one razor assembly 10_1 according to the first embodiment is represented by a solid line, and another razor assembly 10_2 according to the first embodiment is represented by a dashed line. The razor assemblies 10_1 and 10_2 according to the first embodiment shown in FIGS. 6, 7, and 8 have the same shape and form, except that they are depicted at different relative positions to each other to indicate a structure that is stacked in the height direction.

Referring to FIG. 6, when the razor assembly 10_1 according to the first embodiment is stacked at the upper side of the stacking direction of another razor assembly 10_2, the side support 216 may be configured to contact at least a portion of the head portion 130 of the other razor assembly 10_2. That is, as the head portion 130 of the razor assembly 10_2 disposed at the lower side of the stacking direction supports the side support 216 of the razor assembly 10_1 stacked at the upper side of the stacking direction, the razor assemblies 10_1 and 10_2 can stably maintain the stacked state.

In the disclosure, the “stacking direction” refers to a direction in which a plurality of razor assemblies 10 and 20 are stacked, and the stacking direction may be parallel to the height direction. For example, the stacking direction may be a direction parallel to the Z axis based on FIG. 1, FIG. 2, FIG. 4, FIGS. 6 to 10, FIG. 17, and FIG. 18, but the disclosure is not necessarily limited thereto.

Referring to FIG. 6, when a razor assembly 10_2 according to the first embodiment is stacked at the lower side of the stacking direction of another razor assembly 10_1, the seating portion 180 of the razor assembly 10_2 positioned at the lower side of the stacking direction may be configured to support the side support 216 of the other razor assembly 10_1.

When the razor assemblies 10_1 and 10_2 according to the first embodiment is stacked in the height direction, the horizontal support surface 181 and the front support surface 182 of the razor assembly 10_2 positioned at the lower side of the stacking direction may support the razor assembly 10_1 stacked at the upper side of the stacking direction. Specifically, the horizontal support surface 181 of the razor assembly 10_2 positioned at the lower side of the stacking direction may be configured to contact the side support 216 of the other razor assembly 10_1 and they may be configured to be in surface contact with each other. The front support surface 182 of the razor assembly 10_2 positioned at the lower side of the stacking direction may be configured to abut the outer surface of the front wall 212 of the other razor assembly 10_1 and they may be configured to be in surface contact with each other.

As the seating portion 180 and the head portion 130 are configured to contact each other when the razor assemblies 10_1 and 10_2 according to the first embodiment are stacked in the height direction, the razor assemblies 10_1 and 10_2 can stably maintain the stacked state without deviating in the transverse direction.

FIG. 7 is a side view cut in the B-B′ direction in a stacked state of a plurality of razor assemblies according to the first embodiment of FIG. 1.

Referring to FIG. 7, the grip portion 140 may include at least one reinforcing rib 243. Each of the at least one reinforcing rib 243 may be formed protruding downward in the height direction from an end of the grip groove 241. Each of the at least one reinforcing rib 243 may be formed extending in a direction different from the extending direction of the body rib 242 and to penetrate the body rib 242. For example, if each of the at least one body rib 242 is configured to extend in a transverse direction from the inside of the grip groove 241, each of the at least one reinforcing rib 243 may be formed extending longitudinally from the inside of the grip groove 241 and to penetrate at least a portion of the at least one body rib 242. The at least one reinforcing rib 243 may perform a function of securing the rigidity of the grip portion 140 and suppressing structural deformation of the razor handle 120.

Referring to FIG. 7, when a razor assembly 10_1 according to the first embodiment is stacked at the upper side of another razor assembly 10_2 in the stacking direction, the central opening 217 may be configured to receive at least a portion of the cantilever 131 of the other razor assembly 10_2. Additionally, at least one of the central receiving portion 218 and the rear receiving portion 219 of the razor assembly 10_1 may be configured to receive at least a portion of the cantilever 131 of the other razor assembly 10_2.

As described above, the cantilever 131 of the razor assembly 10_2 positioned in the lower stacking direction may support the central receiving portion 218 and/or rear receiving portion 219 of the cartridge protector 110 of the razor assembly 10_1 positioned in the upper stacking direction. Therefore, the razor assemblies 10_1 and 10_2 according to the first embodiment can stably maintain the stacked state in the height direction.

FIG. 8 is a cross-sectional view cut in the C-C′ direction in a stacked state of a plurality of razor assemblies according to the first embodiment of FIG. 3.

Referring to FIG. 8, when a razor assembly 10_1 according to the first embodiment is stacked at the upper side of another razor assembly 10_2 in the stacking direction, the grip groove 241 may be configured to contact the outer circumferential surface of the grip protrusion 141 of the other razor assembly 10_2. Specifically, at least a portion of the inner surface of the grip groove 241 of the razor assembly 10_1 disposed at the upper stacking direction may be configured to contact at least a portion of opposite longitudinal sides of the grip protrusion 141 of the other razor assembly 10_2. Therefore, when the razor assemblies 10_1 and 10_2 according to the first embodiment are stacked in the height direction, the razor assemblies 10_1 and 10_2 can be prevented from deviating longitudinally and stably maintain the stacked state.

Additionally, one end of each of at least one body rib 242 of the razor assembly 10_1 may be configured to contact the grip protrusion 141 of the other razor assembly 10_2. Accordingly, the razor assembly 10_2 positioned in the lower stacking direction can stably support the razor assembly 10_1 positioned in the upper stacking direction.

In FIGS. 6 to 8, two razor assemblies 10_1 and 10_2 according to the first embodiment are shown stacked, but the disclosure is not limited thereto, and, for example, it is possible to stack three or more razor assemblies 10 according to the first embodiment.

The razor assembly 20 according to the second embodiment of the disclosure may be configured to be mutually stackable with another razor assembly having the same size and shape. Hereafter, a structure in which the razor assembly 20 according to the second embodiment of the disclosure is stacked in the height direction will be described.

FIG. 9 is a side view cut in the D-D′ direction in a stacked state of a plurality of razor assemblies according to the second embodiment of FIG. 4. In FIGS. 9 and 10, to indicate that the razor assemblies 20 according to the second embodiment are stacked in the height direction, one razor assembly 20_1 according to the second embodiment is represented by a solid line, and another razor assembly 20_2 according to the second embodiment is represented by a dashed line. The razor assemblies 20_1 and 20_2 according to the second embodiment shown in FIGS. 9 and 10 have the same shape and form, except that they are depicted at different relative positions to each other to indicate a structure that is stacked in the height direction.

Referring to FIG. 4 and FIG. 9, the connector 160 may include a connector protrusion 161. The connector protrusion 161 may be formed protruding in the thickness direction from the connector 160. However, the disclosure is not necessarily limited thereto, and the specific shape of the connector protrusion 161 may be appropriately changed within a range that allows the razor assemblies 20_1 and 20_2 to stably maintain a stacked state. For example, the connector protrusion 161 may be formed protruding upward in the height direction.

As illustrated in FIG. 9, when the razor assembly 20_1 according to the second embodiment is stacked at the upper side of the other razor assembly 20_2 in the stacking direction, at least a portion of the cartridge protector 110 of the razor assembly 20_1 may be configured to contact at least a portion of the connector protrusion 160 of the other razor assembly 20_2.

Referring to FIG. 9, the central opening 217 of the cartridge protector 110 of the razor assembly 20_1 positioned in the upper stacking direction may receive at least a portion of the connector 160 of the razor assembly 20_2 positioned in the lower stacking direction. Additionally, the connector 160 of the razor assembly 20_2 positioned in the lower stacking direction may be configured to contact and support at least a portion of the rear receiving portion 219 of the razor assembly 20_1 positioned in the upper stacking direction. Therefore, a distance between the pair of connector protrusions 161 of the razor assembly 20_2 may correspond to a longitudinal width of the central opening 217 of the cartridge protector 110.

As described above, as the connector 160 of the razor assembly 20_2 positioned in the lower stacking direction supports the cartridge protector 110 of the razor assembly 20_1 stacked in the upper stacking direction, the razor assemblies 20_1 can stably maintain the stacked state.

FIG. 10 is a cross-sectional view cut in the E-E′ direction in a stacked state of a plurality of razor assemblies according to the second embodiment of FIG. 5.

Referring to FIG. 10, when a razor assembly 20_1 according to the second embodiment is stacked at the upper side of another razor assembly 20_2 in the stacking direction, at least a portion of the inner surface of the grip groove 241 of the razor assembly 20_1 disposed at the upper side of the stacking direction may be configured to contact at least a portion of opposite longitudinal sides of the grip protrusion 141 of the other razor assembly 20_2. Therefore, when the razor assemblies 20_1 and 20_2 according to the second embodiment are stacked in the height direction, the razor assemblies 20_1 and 20_2 can be prevented from deviating in the longitudinal direction and stably maintain the stacked state in the height direction.

By stably implementing a state in which a razor assembly 10 according to the first embodiment of the disclosure and a razor assembly 20 according to the second embodiment are stacked in the height direction, the arrangement state of a plurality of razor assemblies 10 and 20 can be easily secured in the packaging process.

In FIG. 9 and FIG. 10, two razor assemblies 20_1 and 20_2 according to the second embodiment are shown stacked, but the disclosure is not limited thereto, and for example, it is possible to stack three or more razor assemblies 20 according to the second embodiment.

A razor assembly 10 according to the first embodiment of the disclosure may be configured such that, with respect to another razor assembly 10 having the same size and shape, the razor cartridges 100 of the razor assembly 10 and the other razor assembly 10 are aligned longitudinally while they face opposite directions to each other.

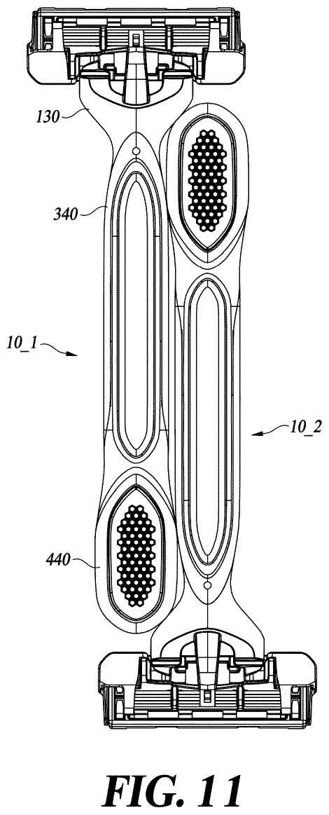

FIG. 11 is a view showing two razor assemblies 10_1 and 10_2 according to the first embodiment being aligned longitudinally while facing different directions. The razor assemblies 10_1 and 10_2 according to the first embodiment shown in FIG. 11 have the same shape and form, except that they are depicted with different relative positions and arrangement shapes to indicate a structure in which each razor cartridge 100 is aligned longitudinally to face opposite directions.

Hereinafter, in FIG. 11 to FIG. 18, the front-rear direction with respect to the placing portion 440 may correspond to the one direction and the other direction of the razor handle 120 described above, respectively.

Referring to FIG. 11, in a reverse arrangement state in which the razor assemblies 10_1 and 10_2 according to the first embodiment face different directions, a longitudinal side of the connecting portion 340 of one razor assembly 10_1 may be configured to contact a longitudinal side of the placing portion 440 of the other razor assembly 10_2. Additionally, a longitudinal side of the head portion 130 of one razor assembly 10_1 may be configured to contact a longitudinal side of the placing portion 440 of the other razor assembly 10_2.

While the razor assemblies 10_1 and 10_2 according to the first embodiment face different directions, at four points of one razor assembly 10_1, that is, a longitudinal side of the head portion 130, a longitudinal side of the connecting portion 340, a rear portion of a longitudinal side of the placing portion 440, and an end portion of a longitudinal side of the placing portion 440, contact with another razor assembly 10_2 is possible. Therefore, with the razor assembly 10 arranged in this manner, the arrangement of the razor assembly can be stably maintained even if external impact or shaking is applied during the packaging process.

In addition, while the razor assemblies 10_1 and 10_2 according to the first embodiment are aligned in the longitudinal direction to face different directions, it is also possible for another razor assembly 10 to be stacked in the stacking direction. Accordingly, by additionally stacking the razor assembly 10 in a state in which the razor assembly 10 is arranged as above, packaging efficiency can be improved.

A razor assembly 20 according to the second embodiment of the disclosure may be configured such that, with respect to another razor assembly 20 having the same size and shape, razor cartridges 100 of the razor assembly 20 and the other razor assembly 20 may be aligned longitudinally so that they face opposite directions.

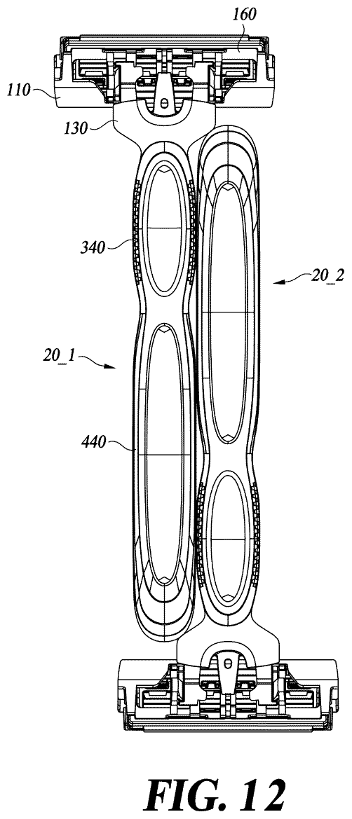

FIG. 12 is a view showing two razor assemblies 20_1 and 20_2 according to the second embodiment being aligned longitudinally while facing different directions. The razor assemblies 20_1 and 20_2 according to the second embodiment shown in FIG. 12 have the same shape and form, except that they are depicted with different relative positions and arrangement shapes to indicate a structure in which each razor cartridge 100 is aligned longitudinally to face opposite directions.

Referring to FIG. 12, in a reverse arrangement state in which the razor assemblies 20_1 and 20_2 according to the second embodiment faces different directions, a longitudinal side of the head portion 130 of one razor assembly 20_1 may be configured to contact a point on a distal end of a longitudinal of the placing portion 440 of the other razor assembly 20_2. Additionally, one longitudinal side of the connecting portion 340 of one razor assembly 20_1 may be configured to contact the rear portion of a longitudinal side of the placing portion 440 of the other razor assembly 20_2, and a longitudinal side middle portion of the placing portion 440 of one razor assembly 20_1 may be configured to contact a longitudinal side middle portion of the placing portion 440 of the other razor assembly 20_2. Additionally, a longitudinal side rear portion of the placing portion 440 of one razor assembly 20_1 may be configured to contact a longitudinal side of the connecting portion 340 of another razor assembly 20_2, and a distal end of a longitudinal side point of the placing portion 440 of one razor assembly 20_1 may be configured to contact a longitudinal side of the head portion 130 of the other razor assembly 20_2.

In a state in which the razor assemblies 20_1 and 20_2 according to the second embodiment face different directions, at a total of five points including three points such as a longitudinal side of the head portion 130 of one razor assembly 20_1, a longitudinal side of the connecting portion 340, and a longitudinal side of the placing portion 440, contact with the other razor assembly 20_2 is possible. Therefore, with the razor assembly 20 arranged in this manner, the arrangement state of the razor assembly can be stably maintained even if external impact or shaking is applied during the packaging process.

A razor assembly 10 according to the first embodiment of the disclosure may be configured such that, with respect to another razor assembly 10 having the same size and shape, razor cartridges 100 of the razor assembly 10 and the other razor assembly 10 may be aligned longitudinally and misaligned from each other while facing the same direction.

A razor assembly 10 according to the first embodiment of the disclosure may be configured such that, with respect to another razor assembly 10 having the same size and shape, razor cartridges 100 of the razor assembly 10 and the other razor assembly 10 may be stacked in the height direction of the razor handle 120 while facing the same direction, and be aligned longitudinally and misaligned from each other with respect to the height direction of the razor handle 120. In the disclosure, the “alignment state” is defined as a state in which a razor assembly 10 and 20, with respect to another razor assembly 10 and 20 having the same size and shape, is aligned such that razor cartridges 100 of the razor assembly 10 and 20 and the other razor assembly 10 and 20 are aligned longitudinally and misaligned from each other while facing the same direction.

Hereinafter, a structure in which the razor assemblies 10 according to the first embodiment of the disclosure are aligned longitudinally while facing the same direction will be described.

FIG. 13 is a front view showing a plurality of razor assemblies 10_1 and 10_2 according to the first embodiment being aligned longitudinally.

FIG. 14 is a partial magnified view of a portion of FIG. 13 showing a head portion 130, razor cartridge 100, and cartridge protector 110 of the longitudinally aligned razor assemblies 10_1 and 10_2.

The razor assemblies 10_1 and 10_2 according to the first embodiment shown in FIGS. 13 and 14 have the same shape and form, except that they are depicted at different relative positions to each other to indicate a structure in which razor cartridges 100 face the same direction and are aligned longitudinally and misaligned from each other.

In FIGS. 13 and 14, two razor assemblies 10_1 and 10_2 according to the first embodiment are shown aligned, but the disclosure is not limited thereto, and, for example, three or more razor assemblies 10 according to the first embodiment may be aligned.

Referring to FIG. 13, in the alignment state, a longitudinal side of the connecting portion 340 of a razor assembly 10_1 may be configured to contact an opposite longitudinal side of the head portion 130 of the other razor assembly 10_2. Additionally, in an alignment state, a longitudinal rear side of the placing portion 440 of a razor assembly 10_1 may be configured to contact a longitudinal front portion of the other razor assembly 10_2, and a longitudinal side of the head portion 130 of a razor assembly 10_1 may be configured to contact at least a portion of the rear of the blade housing 150 of the other razor assembly 10_2.

Referring to FIG. 14, the razor handle 120 of the razor assembly 10 according to the first embodiment of the disclosure may include an engaging portion 231. The engaging portion 231 may be formed protruding downward from the head portion 130. The engaging portion 231 may perform a function of preventing the razor assembly 10 from deviating in the transverse direction in an alignment state.

In an alignment state, a side surface of the engaging portion 231 of a razor assembly 10_1 may be configured to contact at least a portion of a rear surface of the blade housing 150 of the other razor assembly 10_2. Thus, in an alignment state, it is possible to prevent a razor assembly 10_1 from moving backward or the other razor assembly 10_2 from moving forward.

The engaging portion 231 may be disposed in front of the razor cartridge 100 and may be formed protruding from at least a portion of the height direction lower surface of the head portion 130. Thus, even when first razor assemblies 10_1 and 10_2 are disposed in an alignment state, it is possible to prevent razor cartridges 100 of the razor assemblies 10_1 and 10_2 from interfering with each other. However, the disclosure is not necessarily limited thereto, and the position and specific shape in which the engaging portion 231 is formed may be appropriately changed within a range that allows a first razor assembly 10 to stably maintain an alignment state.

A razor assembly 20 according to the second embodiment of the disclosure may be configured such that, with respect to another razor assembly having the same size and shape, razor cartridges 100 of the razor assembly 20 and the other razor assembly 20 are aligned longitudinally and misaligned from each other while facing the same direction. Hereinafter, a structure in which the razor assembly 20 according to the second embodiment of the disclosure is aligned longitudinally while facing the same direction will be described.

FIG. 15 is a front view showing a plurality of razor assemblies 20_1 and 20_2 according to the second embodiment being aligned longitudinally.

FIG. 16 is a partial magnified view of a portion of FIG. 15 showing a head portion 130, razor cartridge 100, and cartridge protector 110 of the longitudinally aligned razor assemblies 20_1 and 20_2.

The razor assemblies 20_1 and 20_2 according to the second embodiment shown in FIGS. 15 and 16 have the same shape and form, except that they are depicted at different relative positions to each other to indicate a structure in which razor cartridges 100 face the same direction and are aligned longitudinally and misaligned from each other.

In FIGS. 15 and 16, two razor assemblies 20_1 and 20_2 according to the second embodiment are shown aligned, but the disclosure is not limited thereto, and, for example, three or more razor assemblies 20 according to the second embodiment may be aligned.

Referring to FIG. 15, in the alignment state, a longitudinal side of the connecting portion 340 of a razor assembly 20_1 may be configured to contact an opposite longitudinal side of the head portion 130 of the other razor assembly 20_2. Additionally, in the alignment state, a longitudinal side of the placing portion 440 of a razor assembly 20_1 may be configured to contact an opposite longitudinal side of the placing portion 440 of the other razor assembly 20_2.

Referring to FIG. 16, in the alignment state, at least a portion of the bottom wall 211 of a razor assembly 20_2 may be configured to contact at least a portion of a surface opposite to the front wall 212 of the other razor assembly 20_1 in the thickness direction of the razor cartridge 100. Thus, in the alignment state, it is possible to prevent one razor assembly 20_2 from moving backward or the other razor assembly 20_1 from moving forward. Thus, in the alignment state, by suppressing the deviation of a plurality of razor assemblies 20 from a predetermined position, alignment stability can be improved, and handling in the packaging process can be improved.

An aspect of the disclosure provides a plurality of razor assemblies including a razor assembly 10 and 20 and another razor assembly 10 and 20 having the same size and shape as the razor assembly 10 and 20.

A plurality of razor assemblies according to an embodiment of the disclosure may include the razor assembly 10 according to the first embodiment. Alternatively, a plurality of razor assemblies according to another embodiment of the disclosure may include the razor assembly 20 according to the second embodiment.

The description of the razor assembly 10 according to the first embodiment and the razor assembly 20 according to the second embodiment is as described above.

A plurality of razor assemblies of the disclosure may be configured such that a razor assembly 10 and 20 and another razor assembly 10 and 20 having the same size and shape are stacked in the height direction relative to each other. The specific structure in which the razor assemblies 10 and 20 are stacked is as described above.

A plurality of razor assemblies of the disclosure may be configured such that a razor assembly 10 and 20 and another razor assembly 10 and 20 having the same size and shape are aligned longitudinally such that razor cartridges 100 of the razor assembly 10 and 20 and the other razor assembly 10 and 20 are aligned longitudinally to face opposite directions to each other. The specific structure in which the razor assemblies 10 and 20 are aligned longitudinally facing opposite directions to each other is as described above.

A plurality of razor assemblies of the disclosure may be configured such that a razor assembly 10 and 20 and another razor assembly 10 and 20 having the same size and shape are aligned longitudinally such that razor cartridges 100 of the razor assembly 10 and 20 and the other razor assembly 10 and 20 are aligned longitudinally while facing the same direction. The specific structure in which the razor assemblies 10 and 20 are aligned longitudinally in the same direction is as described above.

According to the plurality of razor assemblies of the disclosure, by ensuring that a plurality of razor assemblies 10 and 20 are stably stacked or aligned, the stacked or aligned arrangement state of the plurality of razor assemblies 10 and 20 can be maintained during the packaging process, and the efficiency of storage and transport can be improved.

An aspect of the disclosure provides a razor assembly system including a razor assembly 10 and another razor assembly 10 having the same size and shape as the razor assembly 10.

The razor assembly system according to an embodiment of the disclosure may include the razor assembly 10 according to the first embodiment. However, the disclosure is not necessarily limited thereto, and for example, the razor assembly system according to an embodiment of the disclosure may include the razor assembly 20 according to the second embodiment.

The description of the razor assembly 10 according to the first embodiment and the razor assembly 20 according to the second embodiment is as described above.

FIG. 17 is a view showing a razor assembly system in which a plurality of razor assemblies according to the first embodiment being stacked and aligned longitudinally while facing different directions.

FIG. 18 is a view showing a razor assembly system in which a plurality of razor assemblies according to the first embodiment being stacked and aligned longitudinally while facing the same direction.

The razor assemblies 10_1, 10_2, 10_3, and 10_4 illustrated in FIGS. 17 and 18 are to indicate a state in which the razor assemblies 10_1, 10_2, 10_3, and 10_4 are stacked in the height direction and arranged longitudinally, wherein they are depicted with different relative positions and arrangement shapes, but have the same shape and form.

In FIGS. 17 and 18, four razor assemblies 10_1, 10_2, 10_3, and 10_4 are shown arranged, but the disclosure is not limited thereto, and, for example, five or more razor assemblies 10 may be arranged. In an embodiment, the razor assembly system of the disclosure may include a total of eight razor assemblies 10 in which four razor assemblies 10 are stacked in the height direction and two razor assemblies 10 are arranged longitudinally.

Referring further to FIGS. 6 to 8, the razor assembly system of the disclosure may be configured such that, in a stacked state where a razor assembly 10_1 is stacked at the upper side of another razor assembly 10_2 in the stacking direction, at least one region of the cartridge protector 110 of the razor assembly 10_1 contacts at least one region of the head portion 130 of the other razor assembly 10_2 at two or more points, and the lower end surface of the razor handle 120 of the razor assembly 10_1 contacts the upper end surface of the razor handle 120 of the other razor assembly 10_2 at three or more points, thereby forming a seating structure. The specific structure in which the razor assembly 10 is stacked is as described above.

Referring further to FIG. 11, in the razor assembly system of the disclosure, contact with another razor assembly 10_1 may be possible at at least four points, including a longitudinal side of the head portion 130 of the razor assembly 10_1, a longitudinal side of the connecting portion 340 included in the grip portion 140 of the razor assembly 10_1, a rear portion of a longitudinal side of the placing portion 440 included in the grip portion 140 of the razor assembly 10_1, and an end portion of a longitudinal side of the placing portion 440 of the razor assembly 10_1. The specific structure in which the razor assembly 10 is aligned longitudinally facing opposite directions is as described above.

Accordingly, as illustrated in FIG. 17, the razor assembly system of the disclosure can improve the efficiency of storage and transport of a razor assembly 10 during the packaging process of the razor assembly 10 by forming a stacking structure in the height direction of the razor assemblies 10_1 and 10_2 and simultaneously stably maintaining a reverse arrangement state in which the razor assemblies 10_1 and 10_3 are arranged longitudinally.

Referring further to FIG. 13, in the razor assembly system of the disclosure, while a razor assembly 10_1 and another razor assembly 10_2 are arranged longitudinally, in a state in which razor cartridges 100 of the razor assembly 10_1 and the other razor assembly 10_2 are misaligned to each other while facing the same direction, a longitudinal side of the head portion 130 of the razor assembly 10_1 may be configured to contact at least a portion of the rear of the blade housing 150 of the other razor assembly 10_2, and a longitudinal side of the placing portion 440 of the razor assembly 10_1 may be configured to contact an opposite longitudinal side of the placing portion 440 of the other razor assembly 10_2. The specific structure in which the razor assembly 10 is aligned longitudinally facing the same direction is as described above.

Accordingly, as illustrated in FIG. 18, the razor assembly system of the disclosure can improve the efficiency of storage and transport of the razor assembly 10 during the packaging process by stably maintaining an alignment state in which the razor assemblies 10_1 and 10_3 are arranged longitudinally while the razor assemblies 10_1 and 10_2 are stacked in the height direction to form a seating structure.

The description above is merely an illustrative explanation of the technical concept of an embodiment, and a person skilled in the art to which the embodiment belongs may make various modifications and variations within the scope of the essential characteristics of the embodiment. Accordingly, embodiments are intended to explain, not limit, the technical concept of the embodiment, and the scope of the technical concept of the embodiment is not limited by the embodiment. The scope of protection of an embodiment shall be interpreted by the claims below, and all technical concepts within an equivalent scope shall be interpreted as being included within the scope of rights of the embodiment.

What is claimed is:

1. A razor assembly configured to be stackable relative to another razor assembly having the same size and shape, the razor assembly comprising:
a razor cartridge comprising a blade housing that extends longitudinally to receive at least one razor blade;
a razor handle comprising a grip portion grasped by a user and a head portion configured to be connected to the razor cartridge; and
a cartridge protector comprising a receiving space configured to receive at least a portion of the razor cartridge,
wherein the razor cartridge comprises a cartridge upper surface where a cutting edge of the at least one razor blade is exposed and a cartridge lower surface opposite to the cartridge upper surface in a thickness direction,
wherein the cartridge protector comprises
a bottom wall configured to face the cartridge upper surface,
a front wall disposed in front of the receiving space, and
a side support formed by recessing of at least one of the front wall and the bottom wall, with at least a portion exposed in the thickness direction,
wherein, when the razor assembly is stacked above the other razor assembly in a stacking direction, and
wherein the side support is configured to contact at least a portion of the head portion of the other razor assembly.

2. The razor assembly of claim 1, wherein the head portion comprises a seating portion formed by recessing of at least a portion of an outer surface of the head portion, and
wherein, a seating portion of the other razor assembly is configured to support the side support of the razor assembly.

3. The razor assembly of claim 2, wherein, the seating portion comprises:
a horizontal support surface configured to contact the side support of the razor assembly; and
a front support surface extending from one end of the horizontal support surface and configured to abut an outer surface of the front wall of the razor assembly.

4. The razor assembly of claim 1, wherein the grip portion comprises a grip protrusion protruding from at least a portion of one side surface of the grip portion, and a grip groove recessed in at least a portion of the other side surface of the grip portion opposite to the one side surface of the grip portion, and
wherein, the inner circumferential surface of the grip groove of the razor assembly is configured to contact the outer circumferential surface of the grip protrusion of the other razor assembly.

5. The razor assembly of claim 4, wherein the grip portion comprises at least one body rib protruding from an end of the grip groove in a direction toward the other side of the grip portion, and
wherein, one end of each of the at least one body rib of the razor assembly is configured to contact the grip protrusion of the other razor assembly.

6. The razor assembly of claim 1, wherein the head portion comprises a cantilever protruding from one side of the head portion and configured to support at least a portion of the blade housing, and
wherein the cantilever is configured to provide a restoring force to the razor cartridge and to support at least a portion of the blade housing by contacting the blade housing.

7. The razor assembly of claim 6, wherein the cartridge protector comprises a central opening formed by penetrating at least a portion of the front wall and at least a portion of the bottom wall, and
wherein, the central opening of the razor assembly is configured to receive at least a portion of a cantilever of the other razor assembly.

8. The razor assembly of claim 6, wherein the cartridge protector comprises:
a central receiving portion recessed in a portion of at least one of the front wall and the bottom wall, with at least a portion exposed in the thickness direction; and
a rear receiving portion recessed in a portion of at least one of the front wall and the bottom wall, with at least a portion exposed in the transverse direction perpendicular to the longitudinal direction, and
wherein the side support is disposed at opposite longitudinal sides of the central receiving portion.

9. The razor assembly of claim 8, wherein, at least one of the central receiving portion of the razor assembly and the rear receiving portion of the razor assembly is configured to receive at least a portion of a cantilever of the other razor assembly.

10. The razor assembly of claim 4, wherein the protruding direction of the grip protrusion is perpendicular to the direction in which the grip portion extends.

11. The razor assembly of claim 1, wherein at least a portion of a longitudinal side surface of the grip portion is formed in the shape of a continuous curved surface.

12. The razor assembly of claim 1, wherein the grip portion comprises a connecting portion disposed adjacent to the head portion and a placing portion disposed in the other direction of the razor handle from the connecting portion, and
wherein, while the razor assembly and the other razor assembly are aligned in the longitudinal direction such that razor cartridges of the razor assembly and the other razor assembly, respectively, face opposite directions,
a longitudinal side of the connecting portion is configured to contact a rear portion of a longitudinal side placing portion of the other razor assembly.

13. A razor assembly, comprising:
a razor cartridge comprising a blade housing extending longitudinally to receive at least one blade; and
a razor handle comprising a head portion configured to be connected to the razor cartridge, a grip portion extending from the head portion, and an engaging portion formed protruding downward from the head portion,
wherein the razor assembly is configured such that, with respect to another razor assembly having the same size and shape, an alignment state is possible in which the razor assembly and the other razor assembly are aligned longitudinally and misaligned from each other while razor cartridges of the razor assembly and the other razor assembly face the same direction, and
wherein one side surface of the engaging portion is configured to contact at least a portion of a rear surface of the blade housing of the other razor assembly.

14. The razor assembly of claim 13, wherein the grip portion comprises a connecting portion disposed adjacent to the head portion, and
wherein, in the alignment state, a longitudinal side of the connecting portion is configured to contact the other longitudinal side of the head portion of the other razor assembly.

15. The razor assembly of claim 13, wherein, in the alignment state, one longitudinal side of the grip portion is configured to contact the other longitudinal side of the grip portion of the other razor assembly.

16. A plurality of razor assemblies comprising a razor assembly and another razor assembly having the same size and shape as the razor assembly and configured to be stackable relative to the razor assembly,
wherein each of the razor assembly and the other razor assembly comprises:
a razor cartridge comprising a blade housing that extends longitudinally to receive at least one razor blade;
a razor handle comprising a head portion configured to be connected to the razor cartridge; and
a cartridge protector comprising a receiving space configured to receive at least a portion of the razor cartridge,
wherein the razor cartridge comprises a cartridge upper surface where a cutting edge of the at least one razor blade is exposed and a cartridge lower surface opposite to the cartridge upper surface in a thickness direction,
wherein the cartridge protector comprises
a bottom wall configured to face the cartridge upper surface,
a front wall disposed in front of the receiving space, and
a side support formed by recessing of at least one of the front wall and bottom wall, with at least a portion exposed in the thickness direction, and
wherein, while the razor assembly is stacked at the upper side of the stacking direction of the other razor assembly, the side support of the razor assembly is configured to contact at least a portion of the head portion of the other razor assembly.

17. A razor assembly system comprising a razor assembly and another razor assembly having the same size and shape as the razor assembly, wherein each of the razor assembly and the other razor assembly comprises:
a razor cartridge comprising a blade housing that extends longitudinally to receive at least one razor blade;
a razor handle comprising a grip portion configured to be grasped by a user and a head portion configured to be connected to the razor cartridge; and
a cartridge protector comprising a receiving space configured to receive at least a portion of the razor cartridge and a front wall disposed in front of the receiving space,
wherein, in a stacked state in which the razor assembly is stacked above the other razor assembly in a stacking direction, at least one region of the cartridge protector of the razor assembly is configured to contact at least one region of the head portion of the other razor assembly at two or more points, and a lower end surface of the razor handle of the razor assembly is configured to contact a upper end surface of the razor handle of the other razor assembly, thereby forming a seating structure having contact at three or more points;
wherein, in an arrangement state in which the razor assembly and the other razor assembly are arranged in the longitudinal direction, in a reverse arrangement state in which razor cartridges of the razor assembly and the other razor assembly face opposite directions, contact with the other razor assembly is possible at at least four points including one longitudinal side of the head portion of the razor assembly, one longitudinal side of the connecting portion included in the grip portion of the razor assembly, a rear portion of one longitudinal side of a placing portion included in the grip portion of the razor assembly, and an end portion of one longitudinal side of the placing portion of the razor assembly, or
wherein, in an alignment state in which the razor cartridges of the razor assembly and the other razor assembly are misaligned from each other while facing the same direction, the longitudinal side of the head portion of the razor assembly is configured to contact at least a portion of the rear of the blade housing of the other razor assembly, and the longitudinal side of the placing portion of the razor assembly is configured to contact the other longitudinal side of the placing portion of the other razor assembly.
